(19) United States
(12) Patent Application Publication
(10) Pub. No.: US 2020/0247221 A1
(43) Pub. Date: Aug. 6, 2020

(54) Remote control car cover carrier container

(71) Applicant: Harry Melvin Smith, Huntersville, NC (US)

(72) Inventor: Harry Melvin Smith, Huntersville, NC (US)

(21) Appl. No.: 16/350,898

(22) Filed: Jan. 31, 2019

(51) Int. Cl. B60J 11/02; B60J 11/04

(52) U.S. Cl. CPC B60J 11/02; B60J 11/04

(57) ABSTRACT

The invention is new in the art of handling a car cover. It is automatic. It stores the cover inside and feeds the cover out to put on any car with ease. The container can be attached to a receiver that slides into a hitch on a car that can travel with you where ever you go. It is easy to reproduce the invention.

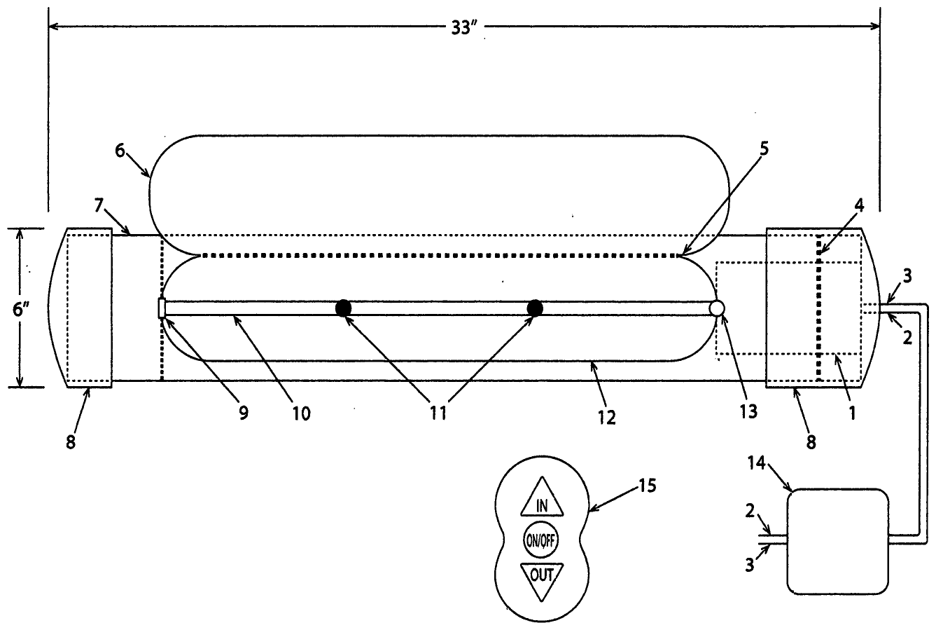

### BACKGROUND OF THE INVENTION

The object of the invention solves the problem of needing help to put a cover on or off a car. The container stores the cover inside while removing any water through weep holes in the container which solves the problem of storing the cover.

### BRIEF SUMMARY OF THE INVENTION

The container allows you to easily guide the cover over the car as it is fed out of the container with the remote control. It makes it quick and easy to cover the car. It removes the cover and automatically puts it into the container ready to use again and store.

### BRIEF DESCRIPTION OF THE DRAWINGS

The drawing shows the container and the placements of all working parts in the container. It is supplied with 12 volts of power from the car battery. The wireless remote is also shown on the drawing. It is self powered.

### DETAILED DESCRIPTION OF THE INVENTION

The carrier body is made of plastic. It is 5″ round and is 33″ long with plastic caps on each end. It has an opening that is 4″×24″ with a stainless steel door. On the left side is a mount with a W′ barring that a steel rod slides into. The right side is supported with a gear driven motor that powers the rod. The car cover is attached to the rod with 2 clamps. As the rod turns it pulls the cover into the container to store it. It also extends it out of the container when it is needed. The container has weep holes in the bottom to drain water from the container if cover is wet. This is controlled with a-wireless remote.

I claim:

1. The design of the invention and the working of the parts.
